(19) United States
(12) Patent Application Publication
(10) Pub. No.: US 2006/0195375 A1
(43) Pub. Date: Aug. 31, 2006

(54) System and method of evaluating credit instruments

(75) Inventor: Jeffrey Bohn, Oakland, CA (US)

Correspondence Address: MORGAN LEWIS & BOCKIUS LLP, 1111 PENNSYLVANIA AVENUE NW, WASHINGTON, DC, 20004, US

(73) Assignee: Moody's Investors Service, Inc.

(21) Appl. No.: 11/068,533

(22) Filed: Feb. 28, 2005

(51) Int. Cl. G06Q 40/00

(52) U.S. Cl. 705/35

(57) ABSTRACT

Systems and methods for analyzing and evaluating credit instruments are disclosed. The systems and methods generate a residual value, including the market's view of loss given default for the credit instrument, based on market pricing information for the credit instrument. The residual value, referred to as iLGD, is indicative of overpricing and/or underpricing of the credit instrument.

### BACKGROUND OF THE INVENTION

1. Field of the Invention

The present invention relates to systems and methods for analyzing and evaluating credit instruments. More particularly, the systems and methods may be used as a tool in the valuation of credit instrument and for selecting credit instruments for purchase or sale, for example, in the management of financial portfolios that include credit instruments.

2. Background of the Prior Art

Credit instruments include loans, bonds, and credit derivatives, such as credit default swaps (CDS). In general, credit instruments relate to a borrower's obligation to repay a debt, often by a series of payments over a period of time. A simple example of a credit instrument is a corporate bond. A corporation issues corporate bonds in order to raise immediate money and then repays the bond holders, with interest, over or after a fixed period of time, such as five years. Credit instruments can be an attractive investment because of the interest payments. In fact, the investment portfolios of institutional investors often include credit instruments.

Once issued, credit instruments may be bought and sold. Thus, the original owner can sell the credit instrument to someone else. Many credit instruments are bought and sold through public markets or privately by banks or other financial entities. For example, bonds, loans, and credit derivatives have been commercially traded through markets in New York, Chicago, London and elsewhere. Trading allows investors to transfer credit instruments to others willing to accept the risks and potential rewards of this investment.

One of the primary risks associated with a credit instrument is the risk of default by the borrower. Default occurs when the borrower does not pay its obligations under the credit instrument. In the example of the five-year corporate bond mentioned above, there is a risk that the corporation will fail to pay off the bond, for example, as a result of bankruptcy. If the borrower defaults, the holder of the credit instrument generally loses some or all of its investment. Thus, the risk of default by the borrower and the amount likely lost in the event of default are important factors in valuing credit instruments.

Moody's KMV Company has analyzed historical data relating to losses suffered by owners of defaulted credit instruments and developed a predictive value known as loss given default (LGD). LGD is defined as:
LGD=1−RR

where RR is the recovery rate of a particular issue or class of issues. The potential credit loss can then be determined as:
Potential Credit Loss=Probability of Default×LGD

LGD is a valuable measure for investors and lenders wishing to estimate future credit losses.

The present invention recognizes that the prices of credit instruments actually traded and, in some cases, the prices offered for buying and/or selling credit instruments, reflect the market's evaluation of the risk of default at a given time. The market's evaluation of risk at a given time may not accurately reflect the actual risk of default, which may be represented by the predictive risk derived from historical data. For a variety of reasons, the market at a given time may underestimate or overestimate the risk associated with a credit instrument. There exists a need to recognize when credit risks are underestimated or overestimated and thereby present trading opportunities for savvy investors.

### SUMMARY OF THE INVENTION

To achieve these and other advantages, and in accordance with the purpose of the present invention as embodied and broadly described, in one aspect of the present invention there is provided a system and method for analyzing and evaluating credit instruments.

In another aspect, the present invention provides a system and method for determining an implied loss given default value for credit instruments.

In another aspect, the present invention provides a system and method for valuation of credit instruments.

In another aspect, the present invention provides a system and method for providing investment information.

In another aspect, the present invention provides a system and method for trading credit instruments.

In another aspect, the present invention provides a system and method for selecting credit instruments for investment.

In another aspect, the present invention provides a system and method for managing the credit risk associated with a portfolio including credit instruments.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention are incorporated in and constitute a part of this specification, illustrate embodiments of the invention and together with the description serve to explain the principles of the invention.

In the drawings:

FIG. 1 is a block diagram of an exemplary computer system for analyzing credit instruments in accordance with an embodiment of the present invention.

FIG. 2 provides a flow chart of an exemplary method for analyzing credit instruments in accordance with an embodiment of the present invention.

FIG. 3 illustrates a flow chart of an exemplary method of processing market price information for credit instruments in accordance with an embodiment of the present invention.

FIG. 4 illustrates a flow chart of an exemplary method of generating composite price data for credit instruments in accordance with an embodiment of the present invention.

FIG. 5 illustrates a flow chart of an exemplary method of generating iLGD values for credit instruments in accordance with an embodiment of the present invention.

FIG. 6 illustrates a histogram of iLGD values for high grade credit instruments.

FIG. 7 illustrates a histogram of iLGD values for high yield credit instruments.

FIG. 8 shows a box graph of iLGD values for high grade credit instruments.

FIG. 9 shows a box graph of iLGD values for high yield credit instruments.

FIG. 10 provides a flow chart of an exemplary trading strategy applying principles of the present invention.

FIG. 11 provides a graph of cumulative monthly returns for high grade bonds according to multiple trading strategies.

FIG. 12 provides a graph of cumulative monthly returns for high yield bonds according to multiple trading strategies.

FIG. 13 shows a block diagram of an exemplary system for trading credit instruments in accordance with the present invention.

### DETAILED DESCRIPTION OF THE PREFERRED EMBODIMENTS

As described further herein, investment opportunites are identified by analyzing and evaluating data related to credit instruments. The results of the analysis may be used in making buy/sell decisions with respect to particular credit instruments and, consequentially, to buy or to sell these credit instruments. The decision-making and trade execution may form part of a system and method of managing a financial portfolio that includes credit instruments. As a result, the systems and methodology described herein are useful for traders, analysts, institutional investors, banks, and/or portfolio managers, among others.

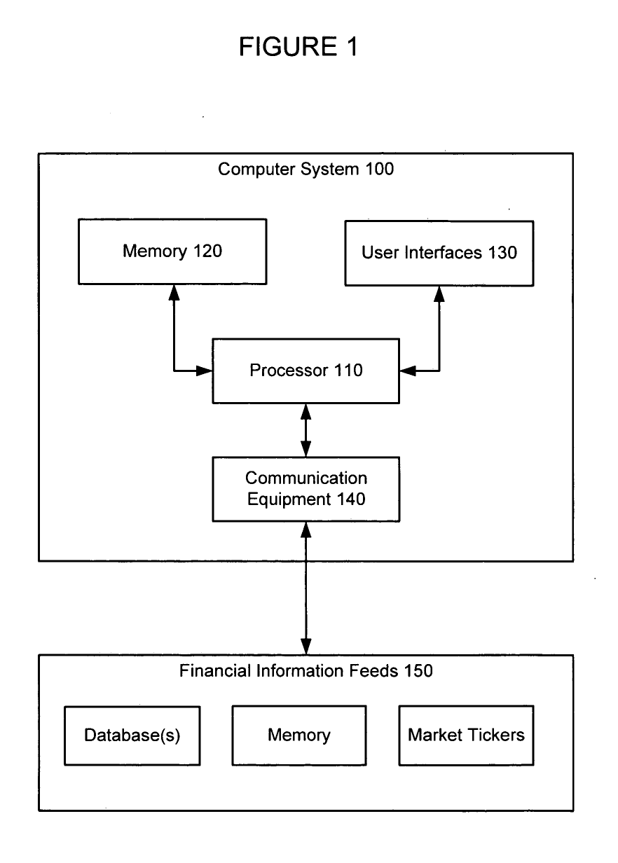

FIG. 1 shows an exemplary computer system 100 that may be used to analyze credit instrument data as described further herein. The computer system 100 may be a desktop or laptop computer system. The computer system 100 includes a processor 110, memory 120 coupled to the processor, user interfaces 130, and communication equipment 140 coupled to the processor 110 and/or the memory 120. The computer system 100 illustrated in FIG. 1 has been simplified for ease of understanding, but it should be understood that computer systems are typically more complicated. The computer system 100 of FIG. 1 is provided as an example of a general-purpose system suitable for use in analyzing credit instrument data. Other systems may be used to analyze credit instrument data, such as multiple computers networked together through one or more networks, a computer system specially equipped or configured for processing financial information as described herein, or a combination of any of the foregoing.

User interfaces 130 may include, for example, one or more of the following: a monitor for displaying a graphic user interface, a keyboard, one or more pointing devices (such as a mouse, tracking ball, or touchpad), and a touch-sensitive screen. Of course, the user interfaces are not limited to the items listed here. The user interfaces 130 may be used to display interim or final results of the financial analysis, trading information, market information (including pricing), among other things. The user interfaces 130 may also be used to control or monitor the processing and/or to display control, monitoring, and processing information.

Communication equipment 140 interfaces with one or more feeds 150 of financial infromation, such as bonds and CDS information. For example, the bonds and CDS information may include transactional and indictive prices along with terms and conditions. The feeds 150 may originate from one or more databases, memories, tickers, or other information sources. For example, feed sources can include Reuter's EJV database of corporate bond data, NASD's TRACE price dissemination project, CDS data from CreditTrade and/or GFINet, bank loan information from LoanX and/or the Loan Pricing Corporation, among others. The feeds 150 may be supplied directly to the computer system 110 or may provided through one or more networks or equipment. The financial information may be raw, unprocessed information or information previously processed by other equipment. The communication equipment 140, of course, may interface with equipment other than the feeds 150.

As noted above, one of the risks associated with credit instruments is the risk of default by the borrower. If the borrower defaults, the investor may lose some or all of her investment. The market's view of this risk of default is reflected in the price of a credit instrument. For example, lower prices are associated with credit instruments for which default is thought to be relatively likely. Higher prices are associated with credit instruments for which default is thought to be relatively less likely. This makes intuitive sense. If default is likely for a credit instrument, then an investor is more likely to lose his investment and therefore would pay only a low price for the credit instrument. Conversely, if default is unlikely for the credit instrument, then an investor is less likely to lose her investment and therefore would pay a higher price for the credit instrument.

An assessment of the market's view of the risk of loss (and possibly other residual factors) is determined, as it provides useful, tangible information to potential investors. Such an assessment is referred to herein as implied loss given default (iLGD). An iLGD value is implied from actual trading data for the credit instrument, such as the trade price of one or more credit instruments, and possibly the bid and/or ask prices for the credit instrument. This value is referred to herein as implied LGD or iLGD, as it is implied based on market price information of the credit instrument. It should be understood that iLGD differs from LGD mentioned above. LGD is typically obtained from statistical analysis of historic LGD data, while iLGD is a value implied derived from actual pricing information.

iLGD may be regarded a risk-neutral measure because it may be implied from market pricing information of credit instruments. Risk-neutral does not mean that investors do not care about risk. On the contrary, it is a term that refers to the post risk-adjustment probability measure. Using risk-adjusted probabilities, the valuation problem can be addressed as if investors are risk-neutral. More precisely, risk-neutral probability is really about prices and pricing. While physical probability refers to the likelihood of an event happening in the future, risk-neutral probability refers to the current price of a dollar (or currency unit) in that event. The notion of risk-neutral probability corresponds to what economists call “state price”—the current price of a dollar if and only if a state occurs. Accordingly, iLGD is pre-default because it is implied from market pricing information before the issuer is in default. It therefore is a market perception of what the loss rate would be if the company defaults over a certain horizon. The market's view of the risk of default at a given time is important because it may not accurately reflect the actual risk associated with the credit instrument. When the market's view of the risk of default differs significantly from the actual risk of default, investment opportunities may exist.

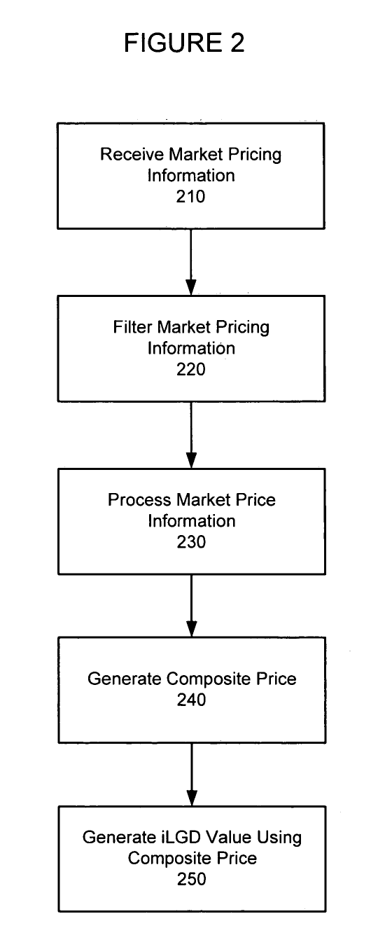

FIG. 2 illustrates an exemplary methodology for determing iLGD values. The methodology can be implemented, for example, using the computer system 100 or other systems described herein. As indicated at step 210, market pricing information for credit instruments is received. For example, the market pricing information may be received by communication equipment 140 from financial information feeds 150 either directly or via one or more network devices.

The market pricing information for credit instruments may be filtered, as indicated at step 220. The filtering process is intended to remove uninformative prices. For example, the filtering may remove, for example, outlier prices, stale prices, data entry errors, credit instruments with unusual features, asset-backed securities, and/or other data considered to induce “noise” in the determination. It should be noted that the computer system 100 may perform the filtering of step 220 or it may receive pricing information that has already been filtered.

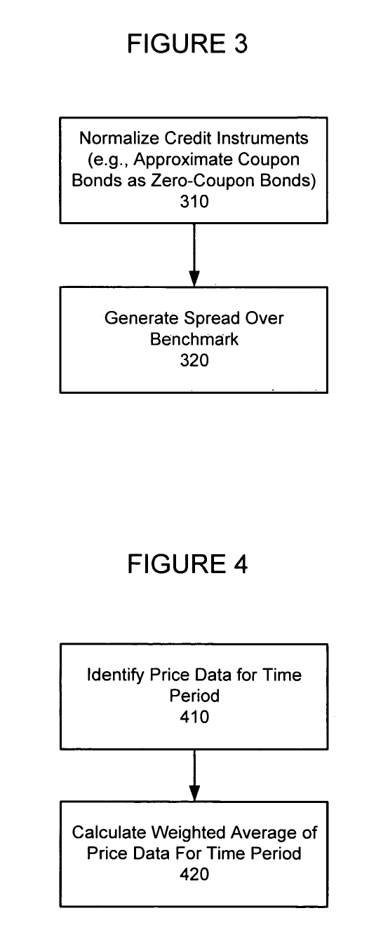

The market pricing information is processed at step 230. The market pricing information may be processed in whole or in part before or after the filtering of step 220. An advantage (but not necessarily the only advantage) of processing the market pricing information after filtering is that it improves the quality of the data going into the model. Processing step 230 will be discussed in further detail in connection with FIG. 3.

Step 240 represents generating a composite price associated with each of the one or more credit instruments under evaluation. A composite price for each credit instrument may be used to avoid undesirable volatility, yet still reflect market dynamics. According to one embodiment, the composite price is generated by pooling price observations for the credit instrument (such as a bond, or a credit default swap or other credit derivative) over a period of time, for example, between two to four months. The time period for the pricing information (e.g., spread data) may be varied. Moreover, the price data points need not be weighted equally in the calculation of the composite price. Various weighting schemes can be used. According to one example, the most recent data points receive the highest weight. For example, the weight function may be an exponential function of time. As should be appreciated, the time period and/or weighting may be calibrated, either statically or dynamically, to provide a desired measure of responsiveness and stability of the iLGD result. For example, if recent price information is assigned a greater weighting than older price information, the derived iLGD value will be more sensitive to recent price information.

As an example, composite price data for a bond may be derived from pricing information over a rolling thirteen week period of bond data. A thirteen week period plus a weighting scheme has been determined empirically to produce very balanced results for iLGD. That is, the thirteen week time period history appears to be sufficiently timely and provides sufficient data to estimate iLGD reliably. However, other time periods and weighting schemes may be used. By way of guidance, if the time period selected is too short, then the estimated iLGD could be too volatile. If the time period is too long, then the estimated iLGD may not promptly track the dynamics of market expectations. Accordingly, an appropriate balance should be achieved.

At step 250, the iLGD value is generated based on the composite price of the credit instrument. As described in more detail below, the iLGD value may be implied using as inputs the Expected Default Frequency (EDF) term structure of the issuer, the market Sharpe ratio estimated from a cross-sectional bond sample, and the size premium estimated for the issuer.

As noted above, iLGD represents an implied measure derived from a valuation model for credit instruments and observed market pricing information. When embodied as an unitless variable, iLGD can lie outside of a normal range of 0% to 100%. This is because iLGD may capture other pricing-relevant information not captured by the other variables, such as EDF, LGD, market Sharpe ratio, duration, size, or the benchmark zero-default curve. It could, for example, include a liquidity effect or potential mis-pricing. It should be noted that iLGD is not a catch-all residual if the daily fluctuation of issue-level spread is averaged out. iLGD provides an informative measure for relative pricing and, as a result, can be used to improve portfolio performance. If an issue's iLGD moves far into the right tail (i.e. greater than 1 or 100%), then it is indicative of an underpriced issue and investors may consider buying it. Conversely, if an issue's iLGD becomes very small or even negative, it is indicative of an issue being overpriced and investors may want to consider selling it.

iLGD may be understood by analogy to implied equity volatility values associated with options. Option traders use the simple Black-Scholes model to back out the underlying equity volatility, which is consistent with the option price. This implied equity volatility may be very different from the historical equity volatility derived from equity returns. The implied volatility may be significantly more volatile and move in large magnitudes up or down. The implied volatility may also incorporate other pricing-relevant information not captured in the Black-Scholes formula. Nevertheless, the implied volatility can be a useful measure for traders and portfolio managers.

FIG. 3 illustrates a method for processing received price information consistent with step 230 of FIG. 2. FIG. 3 is intended to be exemplary, not exhaustive or even necessary. Step 310 represents the normalization of the credit intruments being evaluated. Different credit instruments can have different features. Therefore, it can be useful to normalize the credit instruments to one or a limited numbers of forms. For example, most corporate bonds are coupon bonds rather than zero-coupon bonds. While coupon bonds may be modeled, it is also possible to approximate coupon bonds as zero-coupon bonds by collapsing the multiple cash flows of the coupon bond at a single point in time. The tenor for this equivalent zero-coupon bond is equal to the Macaulay duration of the coupon bond. As a result, step 310 may be used to normalize market pricing information by converting the pricing information for couponed corporate bonds to an equivalent zero-coupon pricing. Consequently, following step 310, the market pricing information for corporate bonds under evaluation represents zero-coupon bonds or zero-coupon equivalents.

In one embodiment, iLGD is a measure of the risk-adjusted expected loss rate derived directly from the time series information of a particular credit instrument's credit spreads. Of course, other expressions of iLGD are possible. FIG. 3 shows generating the spreads for the credit instruments under evaluation at 320. The spread of a credit instrument represents the price component in excess of a benchmark value. For example, if the yield of the credit instrument is 455 basis point (bp) and the benchmark value is 322 bp then the spread is 133 bp (i.e., 455-322).

The benchmark value can represent or approximate a default-free curve. A default-free curve reflects the rate curve for an issue having zero risk of default. The default-free curve may be approximated by the U.S. Treasury curve, a LIBOR-based curve, a variant of the foregoing, or another representation. According to one embodiment, the benchmark curve may be a LIBOR-based curve adjusted downward slightly to account for the small amount of credit risk reflected in LIBOR rates.

As note above, step 230 of FIG. 2 may include additional or different processing than indicated in FIG. 3. Moreover, the order of steps in FIG. 3 is exemplary, not necessary.

FIG. 4 illustrates exemplary steps for generating a composite price consistent with step 240 of FIG. 2. Price data (e.g., spreads) for a selected time period are identified at step 410. Next, a weighted average of the price data is calculated at step 420 to generate the composite price data.

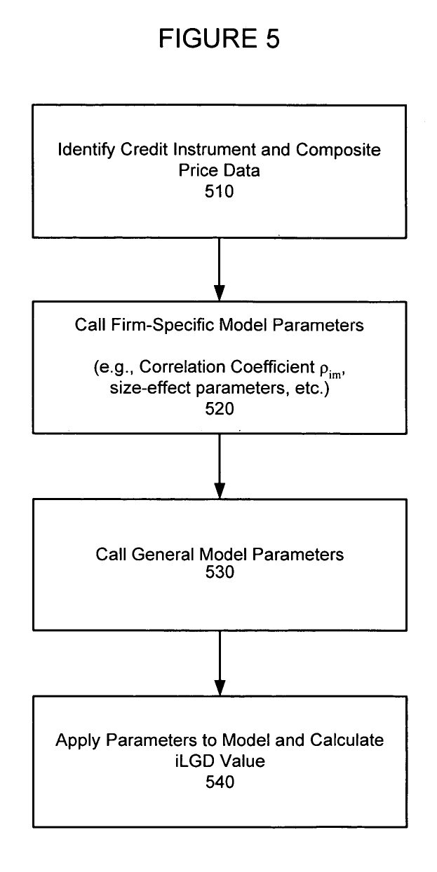

FIG. 5 illustrates exemplary methodology for generating iLGD values based on the composite price data consistent with steps 240 and 250 of FIG. 2. It should be understood that the method of FIG. 5, including the model used, are intended to be exemplary. Prior to describing the methodology, background information will be provided. Under the risk neutral valuation principle, the model spread (EDF Implied Spread or EIS) on a defaultable zero-coupon bond can be characterized as:

$${S}_{T} = {β}_{z} f ( {z}_{t} ) - \frac{1}{T} ln ( 1 - N [ {N}^{- 1} ( {CEDF}_{iT} ) + {ρ}_{tm} {λ}_{m} √ \overline{T} ] \times iLGD )$$

where S_{T} is the spread value, z is the firm size, f(z) is a size-function calibrated from bond data, and β_{z} is the size premium parameter, T is the tenor, N is the cumulative standard normal distribution, CEDF is the probability of default from now until the horizon specified by T, ρᵢₘ is the correlation coefficient of individual asset returns with the market returns, λₘ is the market price of risk, and iLGD is implied value referred to above.

Parameters z,f(z), and β_{z} account for the empirical observation that bonds of smaller firms tend to have significantly higher spreads than comparable bonds issued by larger firms. CEDF is a measure of probability of default and can vary by company and by tenor.

The market price of risk parameter λₘ represents corporate debt investors' attitude toward risk. Alternatively, λₘ can be interpreted as the market's Sharpe ratio or expected excess return demanded by investors per unit of risk. This attitude toward risk for credit market investors is best reflected in the prices or spreads of credit risky claims. Consequently, historical data of this type can used to calibrate λₘ. Historical credit spread data can also be used to calibrate other model parameters like the firm size premium.

Generally, the valuation model has been used to solve for the spread value S_{T} using an LGD value derived from historical data. However, when the composite price data is applied as the spread value S_{T}, then the model may be used to solve for iLGD.

iLGD may be calculated separately for different credit instruments. For example, iLGD value may be calculated based on CDS data and a separate iLGD value based on bond spreads. If insufficient pricing data exists for a particular credit instruments, then an associated iLGD value need not be calculated. In that case, users may use an iLGD value for a given issuer estimated from other credit instruments of the issuer as a substitute. For example, if CDS data for an issuer is insufficient, then an iLGD for bonds for that issuer may be used as a substitute. For example, one or more reference bond issues can be selected that are likely to be related to a CDS on the same name. The iLGD values corresponding to this set of bonds are considered good candidates to use for pricing a CDS.

With reference to FIG. 5, iLGD values are generated first by identifying a credit instrument and its associated composite price data, at step 510. This step may include identifying information associated with the credit instrument, such as issuer firm name or other firm identifier, tenor of the credit instrument, etc. The firm-specific model parameters are called at step 520. For example, the firm-specific correlation coefficient ρᵢₘ is called and any firm-specific size effect parameters may be called from memory. Thus, if the identified credit instrument is a particular bond issued by Exxon Corporation, then the correlation coefficient ρᵢₘ and size effect parameter(s), if any, for Exxon are called from memory. At step 530, the general market model parameters are called from memory. For example, the market price of risk λₘ may be called. At step 540, the firm-specific and general market parameters, as well as the composite price data and any other relevant credit instrument parameters, are input to the model and used to calculate the iLGD value for the credit instrument. As should be appreciated, iLGD values may be calculated for a number of credit instruments.

Having described exemplary methods for generating iLGD values, the accuracy of the iLGD values will now be discussed. iLGD values were generated for a number of credit instruments. A 95% confidence interval means that 95% of the time the true value falls within a specified range. As indicated in the table below, most of the 95% confidence intervals are within ±10% of the iLGD themselves. Some examples follow:

Examples of Implied LGD measures

| | | |
|---|---|---|
| | Implied | 95% Confidence |
| Name | LGD | Level |

| | | | |
|---|---|---|---|
| Albertsons | 0.489 | 0.477 | 0.502 |
| Alcoa | 0.158 | 0.149 | 0.167 |
| Polymer Group | 1.330 | 1.323 | 1.337 |

Based on the table above, the iLGD was outside of the given range 5% of the time (with 2.5% in each tail, above the high end or below the low end). Most of the implied LGDs (around 80%) are between 0% and 100%, with implied LGD values showing some mean-reverting tendencies. For example, an iLGD value greater than 100% suggests that a bond might be underpriced because the spread appears too wide relative to the bond's EDF. An iLGD value less than 0% suggests that the bond might be overpriced.

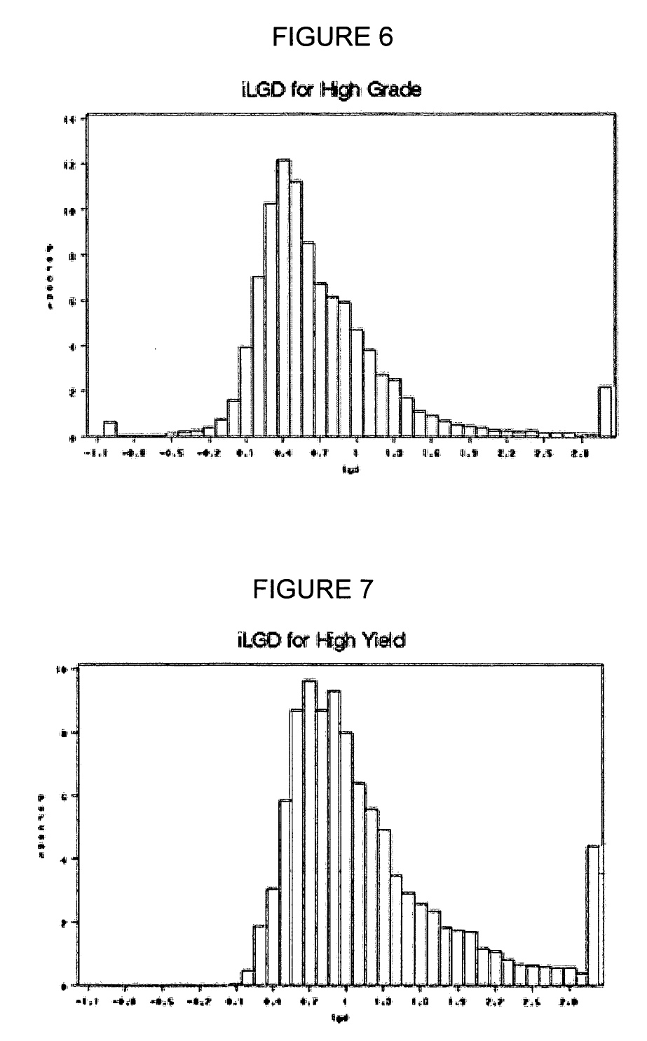

iLGD values are very dynamic. FIGS. 6 and 7 illustrate histograms of iLGD values for high grade and high yield issuers, respectively. The median iLGD value for investment grade and high yield issuers are 0.5614 and 0.9782, respectively. The standard deviation of iLGD values for investment grade and high yield issuers are 1.2646 and 1.7999, respectively.

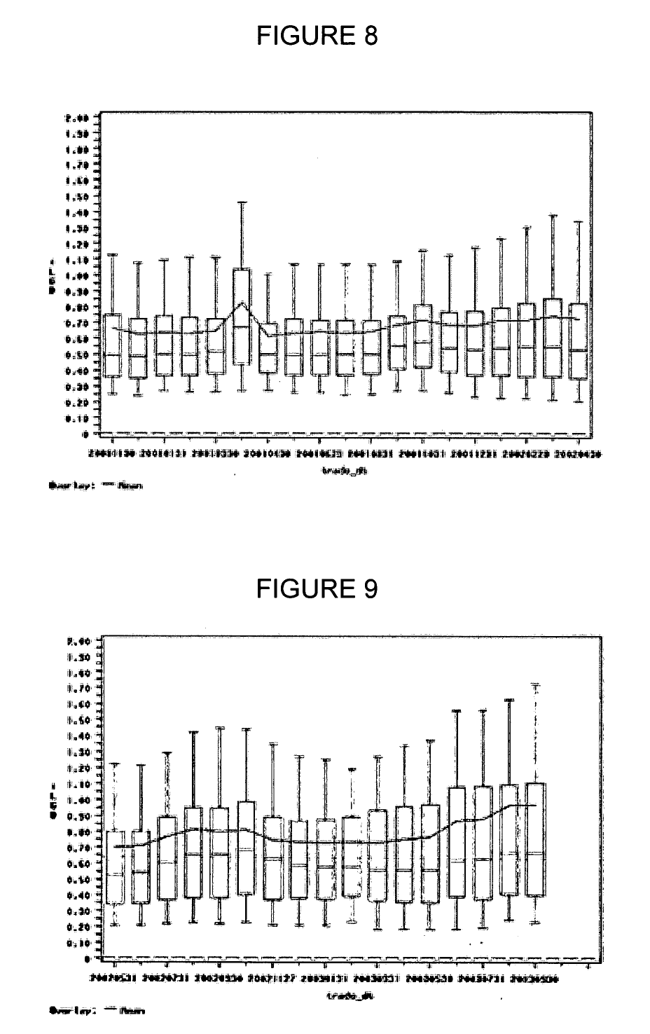

FIGS. 8 and 9 illustrate box plots for a high grade issuer and a high yield issuer, respectively. The box plots chart iLGD values over a given time period. More particularly, each box plot shows the high and low iLGD values, the standard deviation, and the mean over a time period. Each graph tracks these values over a roughly two-year period. Most of the time, the distributions are relatively stable. However, when the credit market deteriorates or when there is mispricing between the credit and equity markets, the distribution can vary over a large range. An iLGD value greater than 100% might mean that the bond is mispriced, the predicted EDF value is underestimated, or other parameters are mis-estimated. Research has shown that, overall, larger iLGD values indicate that a bond is undervalued.

More generally, iLGD values can be used as a trading signal to improve portfolio performance. For example, iLGD values may be used directly or may be used as input values to generate other useful information. For example, iLGD values may be compared to threshold values or to other calculated values (e.g., LGD) in determining or gauging the relative value of a credit instrument of set of credit instruments. Alternatively, iLGD may be used as an input value, for example, in a valuation model for a credit instrument. As noted above, iLGD may be based on composite price information. Accordingly, iLGD values may be used to estimate prices when no price information available, for example, on days when the credit instrument (e.g., a bond) does not trade or with respect to credit derivatives. By way of example, a price for a credit derivative, such as a CDS, may be determined using one or more iLGD values for traded credit instruments.

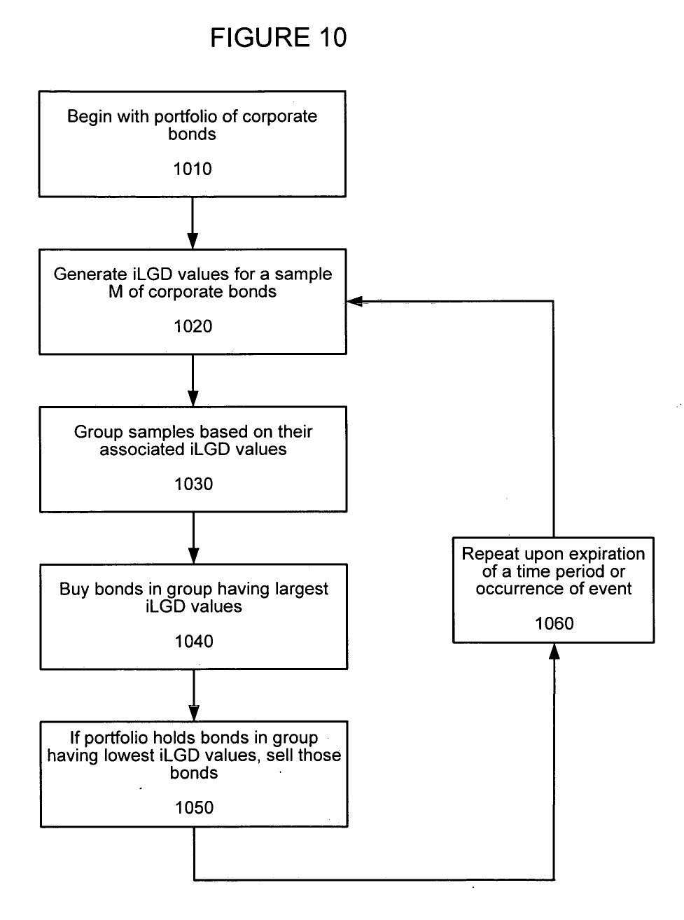

FIG. 10 illustrates a simple trading strategy that may be applied. The method begins with a portfolio of corporate bonds, as indicated at step 1010. However, this is not required, as the trading strategy may be used to acquire a portfolio. At step 1020, iLGD values are calculated for a sample of M corporate bonds. Preferrably, the sample of bonds is large and represents the set of candidates for addition or removal from the portfolio. The sample set may be grouped based on the calculated iLGD values, as indicated at step 1030. In particular, the high extreme values of iLGD may be grouped together and the low extreme values may be grouped together. As used here, “extreme” does not refer only to the highest iLGD value or to the lowest iLGD value, but instead can refer to a set of high values or a set of low values. An iLGD value is included in the grouping or set depending on whether it meets one or more criteria. It should be understood that grouping in this context may be performed using a computer. Accordingly, the “grouping” does not actually require transfer or movement of data within computer memory. Rather, grouping in this context may be notional.

By way of example, the sample set may be grouped in quartiles based on iLGD values. Of course, other grouping criteria are possible. For example, bonds may be grouped according to the X highest iLGD values and the Y lowest iLGD values, where X and Y are integers (and may be equal). As a further example, the groupings may be based on iLGD threshold values. The iLGD threshold values may correspond to an iLGD value or a percentage of iLGD values. The threshold may be predefined or may be determined dynamically, for example, by statistical analysis of the sample set and/or historical samples.

The bonds in the group with the largest iLGD values may be considered the most undervalued. Conversely, the bonds in the group with the lowest iLGD values may be considered the least undervalued (or most over-valued). Bonds in the group with the highest iLGD values are bought and added to the portfolio. This is indicated at step 1040. Bonds included the portfolio and in the lowest group of iLGD values are sold and, thus, removed from the portfolio, as indicated at step 1050. Before the purchase or sale of bonds identified by the groupings, additional steps may be performed. Some additional research or evaluation may be desired to gauge if there is a particular reason for the extreme value, such as news reports or rumors of imminent corporate financial failure, of government action or inaction (such as an SEC investigation, adverse judicial ruling, FDA approval, etc.), or news reports or rumors concerning competitors, customers, or suppliers. In addition, or in the alternative, a portfolio manager may compare the iLGD values of the bonds to predictive LGD values. Such additional evaluation may narrow down the number of bonds targeted for purchase or sale.

According to one example, the set of bonds are grouped into quartiles based on their iLGD values. Each quartile is maintained as a separate portfolio. If the iLGD value of a bond changes so that the iLGD value transitions from one quartile to another, then the bond is bought and sold accordingly. For example, if the iLGD value of a bond transitions from the fourth quartile to the third quartile, then the bond is sold from the fourth quartile bond portfolio and bought into the third quartile bond portfolio.

At step 1060, the methodology is repeated periodically (e.g., daily, weekly, monthly, etc.) and/or upon the occurrence of an event. For example, the portfolio may be rebalanced monthly with bonds bought and sold according to their iLGD values. For example, bonds with iLGD values entering in the highest iLGD group may be added to the portfolio. Bonds with iLGD values leaving the highest iLGD group may be sold. According to the quartile example provided above, bonds having iLGD values that transition between quartile groups are bought and sold accordingly. As above, if a bond has an iLGD value transitioning from the third quartile to the fourth quartile, then the bond is sold from the third quartile bond portfolio and bought into the fourth quartile bond portfolio.

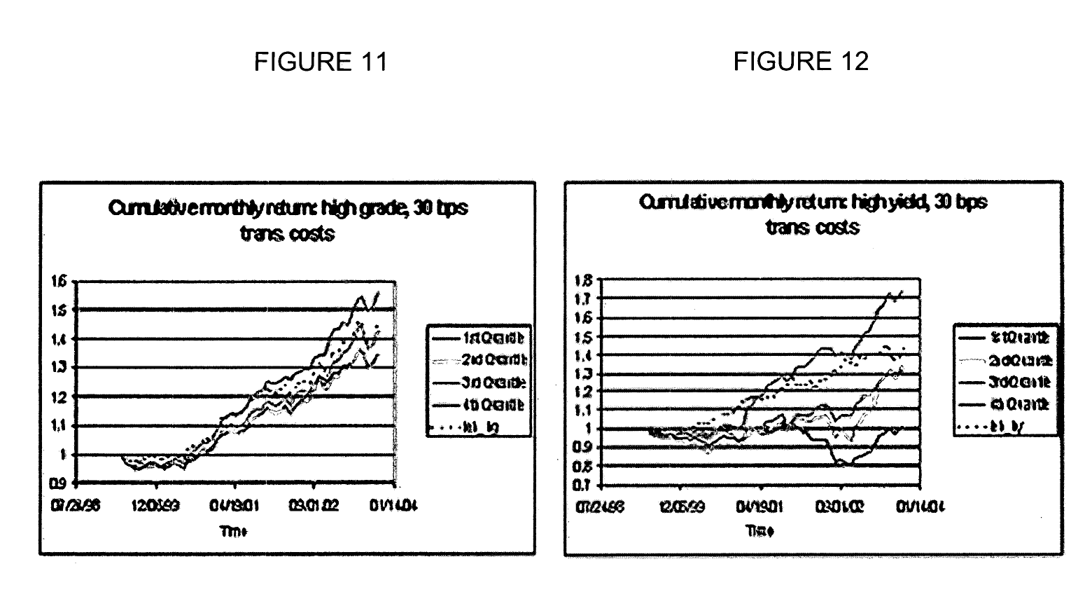

FIGS. 11 and 12 illustrate the results of the exemplary strategy for a set of high grade bonds and a set of high yield bonds, respectively. The quartile portfolios were tracked over time. A one-way transaction cost of 30 basis points was assumed for purchases and sales. Cumulative total monthly returns of the quartile portfolios are compared the cumulative total monthly returns of the Lehman Investment Grade and High Yield Bond Indices, respectively. As indicated by FIGS. 11 and 12, the very simple trading strategy consistently outperformed other portfolios including the Lehman bond index portfolios.

As indicated above, iLGD values are useful measures for pricing credit instruments because they are risk-neutral (or risk-adjusted) measures that reflect the debt market's collective expectation on the bond's loss given default. They provide a good starting point for a more fundamental model that can provide an independent risk-adjusted expected LGD measure. Users (e.g., traders or portolio managers) can at any time input their own LGD to compute a “fair value” spread and then contrast this with market spread to identify potentially mispriced assets.

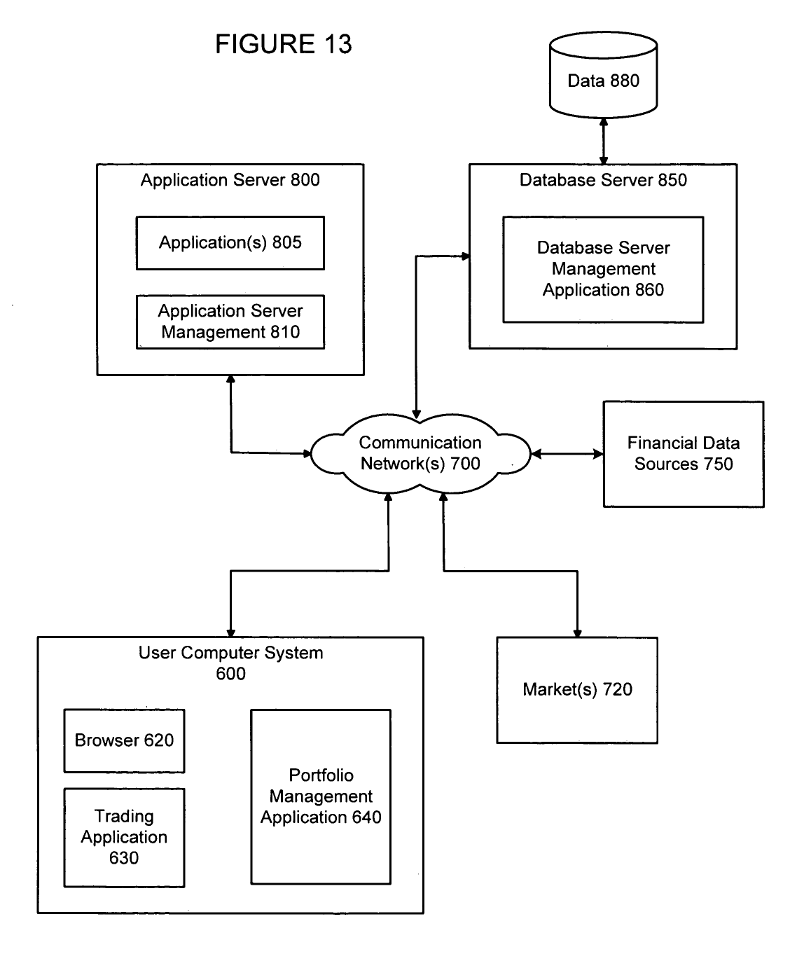

FIG. 13 illustrates an embodiment of a system according to an exemplary embodiment of the present invention. According to the embodiment of FIG. 13, the system may be embodied as a internet/desktop-based system. A user computer system 600 may be connected to communication network(s) 700. The user computer system 600 can include a browser application 620 as well as other software. For example, user computer system 600 may include other financial applications, such as a trading application 630 and a portfolio management application 640. User computer system 600 may be a single computer or a network of computers.

The trading application 630 may facilitate trading of one or more credit instruments, such as bonds or credit derivatives. In this regard, the trading application 630 may communicate (directly or indirectly) with a market 720 to receive market information and/or transmit instructions (such as orders or quotes) to buy and/or sell credit instruments or other securities. For example, the trading application 630 may communicate with a broker or market maker associated with market 720. The broker or market maker facilitates trading through market 720, for example, by taking buy or sell orders and executing them through the market. In this regard, market 720 shown in FIG. 13 includes the broker or market maker.

Alternatively, the trading application 630 may communicate with a market 720 that electronically matches bids and offers from buyers and sellers. In such a case, orders and/or quotes to buy or sell a credit instrument (such as a bond or credit derivative, like a CDS) may be transmitted from the trading application 630 to the market 720 for electronically matching to corresponding orders. The portfolio management application 640 may include a database listing the financial holdings of the user, such as firm name, type of holding, and quantity of holding. The portfolio management application 640 may also interface with the browser 620 to facilitate the analysis and evaluation of credit instruments.

An on-site or off-site application server 800 and database server 850 are also provided. Communication network(s) 700 interconnects the user computer system 600 and the servers 800 and 850. The interconnection may be direct or indirect. The communication network(s) 700 may comprise a wide-area network, including one or more communication links and one or more sub-networks, and one or more local area networks. For example, the user computer system 600 may connect to the application server 800 through a wide-area network, (e.g., the internet) and a local area network that includes the application server 800 and the database server 850. Alternatively, communication network 700 may include a local area network that connects the user computer system 600, the application server 800, and the database server 850.

Application server 800 includes a server management application 810 that communicates with the browser 620. Server management application 810 further communicates with database server 850. While FIG. 13 illustrates the interconnection between application server 800 and database server 850 as a networked connection (e.g., a local area network connection), the application server 800 may be directly connected to the database server 850. Application server 800 further includes one or more applications 805 that facilitate the analysis and evaluation of credit instruments, as described in more detail below.

Database server 850 includes database services management application 860 that manages storage and retrieval of data from one or more databases 880. Database server 850 additionally communicates with financial information sources 750 to receive updated financial information, such as market pricing information for credit instruments. For example, financial data sources 750 can include Reuter's EJV database of corporate bond data, NASD's TRACE price dissemination project, CDS data from CreditTrade and/or GFINet, bank loan information from LoanX and/or the Loan Pricing Corporation, among others.

Operation of the system will now be described. A trader or a portfolio manager may operate trading application 630 and portfolio management application 640 in order to manage a portfolio including credit instruments. As such, the trading application 630 may be used to facilitate trading of the credit instruments through the markets 720. The portfolio management application 640 may be used to monitor the content of the portfolio. The portfolio may be maintained for purposes of investment, such as for a mutual fund, a private fund (e.g., a retirement fund, the holdings of a business, a university, or foundation, etc.), or a government fund, or may represent the holdings of a trader.

The browser 620 may be used to access the application server management 810 and, thereby, obtain credit instrument analysis information. The browser 620 may receive the credit instrument analysis information from application(s) 805 via application server management 810.

Application(s) 805 may collect price information from database server 850. The price information may be historical information and/or composite prices for credit instruments. The applications 805 may use that price information to generate iLGD values for a set of credit instruments, for example, as described above. Alternatively, one or more additional processors (not shown) may be used to generate the iLGD values, which can be stored in database 880. In this case, the application(s) 805 may access the database 880 via database server 850 to obtain the iLGD values. The iLGD values may be generated according to the methodology and using the equipment described above.

The set of credit instruments may be defined per a request from user computer system 600. The request may be stored in memory and indexed to an account associated with the user computer system 600 or the operators thereof. Application(s) 805 may supply the iLGD values and possibly other information to the user computer system 600 via the application server management 810 and the communication network 700. Application(s) 805 may supply the iLGD values upon request received from user computer system 600, per a predetermined schedule (e.g., daily, weekly, etc.), and/or upon the occurrence of some event, such as the transition of an iLGD of a credit instrument into or out of an extreme grouping or set.

User computer system 600 may receive the transmission from application server 800. The received iLGD values may be analyzed and/or further evaluated and buy/sell decisions for credit instruments can be based on the iLGD values. For example, the trading application 630 may be used to transmit buy or sell orders based at least in part on the received iLGD values.

While iLGD values may be obtained and transmitted as described above, related information may alternatively or additionally be obtained and transmitted. For example, indexes or rankings of firms and/or credit instruments based at least in part on the iLGD values, identities of the firms and/or credit instruments in the extreme groups, or identities of firms and/or credit instruments moving into and out of the extreme groups. Any of this information may be used, at least in part, to make buy/sell decisions regarding credit instruments and those buy/sell decisions may be implemented through trading application 630.

As described above, the system may include a local area network that includes user computer 600, servers 800 and 850. It should be understood that various system architectures may be used to implement the system of the present invention.

It will be apparent to those skilled in the art that various modifications and variation can be made in the methods and systems described above without departing from the spirit or scope of the invention. Thus, it is intended that the present invention cover the modification and variants of this invention provide they come within the scope to the appended claims and their equivalents.

What is claimed is:

1. A system for evaluating credit instruments, comprising:
(a) communication equipment for receiving market pricing information for a plurality of credit instruments; and
(b) at least one processor for (i) filtering the market pricing information, (ii) processing the filtered market pricing information to produce processed market pricing information for a credit instrument of the plurality of credit instruments, (iii) generating composite pricing data for the credit instrument, the composite pricing data derived from the processed market price information for the credit instrument and historical market price information, and (iv) generating an iLGD associated with the credit instrument based on the composite pricing data, the iLGD value represents a residual value including a market price-implied loss given default of the credit instrument.

2. The system of claim 1, wherein the processor filters the market pricing information to remove pricing information useful to generate the iLGD value.

3. The system of claim 1, wherein the credit instruments include corporate bonds having coupons and wherein the processor processes the filtered market pricing information to generate zero coupon-equivalent market pricing information corresponding to selected corporate bonds having coupons.

4. The system of claim 1, wherein the processor generates composite pricing data at least by calculating a weighted average.

5. The system of claim 1, wherein the iLGD value is generated based on the composite pricing data and at least a market price of risk factor.

6. The system of claim 1, wherein the iLGD value is generated based on the composite price data and at least a size effect factor associated with the size of an obligor of the credit instrument.

7. The system of claim 1, wherein the iLGD value is generated based on the composite price data and at least a firm-specific correlation coefficient of individual asset returns with market returns.

8. The system of claim 1, further including a user interface device for displaying the iLGD value.

9. The system of claim 1, wherein the communication equipment transmits the iLGD value to other equipment via a network.

10. The system of claim 1, wherein the at least one processor determines a set of iLGD values for a plurality of credit instruments and groups credit instrument information based on the iLGD values.

11. The system of claim 1, wherein the at least one processor controls the communication equipment to transmit data based on the iLGD values via a network.

12. The system of claim 11, wherein the transmitted data comprises identification of a set of credit instruments based on the iLGD values.

13. A method for evaluating a credit instrument, comprising:
receiving market pricing information for a plurality of credit instruments;
filtering the market pricing information for the plurality of credit instruments;
processing the filtered market pricing information to produce processed market pricing information for a credit instrument of the plurality of credit instruments;
generating composite pricing data for the credit instrument, the composite pricing data derived from the processed market price information for the credit instrument and historical market price information; and
generating an iLGD associated with the credit instrument based on the composite pricing data, the iLGD value represents a residual value including a market price-implied loss given default of the credit instrument.

14. The method of claim 13, wherein the step of filtering market pricing information comprises removing pricing information uninformative to the step of generating an iLGD value.

15. The method of claim 13, wherein the step of processing the market pricing information includes normalizing the filtered market pricing information.

16. The method of claim 15, wherein the credit instruments are corporate bonds and the step of normalizing the filtered market pricing information comprises using the filtered market pricing information of selected corporate bonds having coupons to approximate market pricing information of equivalent corporate bonds without coupons.

17. The method of claim 13, wherein the step of processing the market pricing information comprises generating spread data, the spread data representing a price premium over benchmark data.

18. The method of claim 17, wherein the benchmark data approximates a zero-default curve.

19. The method of claim 13, wherein the step of generating composite price data comprises calculating a weighted average.

20. The method of claim 13, wherein the residual value is generated based on the composite pricing data and at least a market price of risk factor.

21. The method of claim 13, wherein the residual value is generated based on the composite pricing data and at least a size effect factor associated with the size of an obligor of the credit instrument.

22. The method of claim 13, wherein the residual value is generated based on the composite pricing data and at least a firm specific correlation coefficient of individual asset returns with market returns.

23. A method for identifying potentially mispriced credit instruments using market price information, comprising:
receiving market pricing information for a set of credit instruments;
calculating an iLGD value for each credit instrument in the set; and
identifying credit instruments in the set of credit instruments having extreme iLGD values as potentially mispriced credit instruments.

24. The method of claim 23, wherein the credit instruments are corporate bonds.

25. The method of claim 23, wherein the credit instruments are credit derivatives.

26. The method of claim 25, wherein the credit instruments are credit default swaps.

27. The method of claim 23, wherein the step of identifying comprises identifying credit instruments in the set of credit instruments having extreme iLGD values using at least one threshold value.

28. The method of claim 27, wherein the threshold value is a fixed numerical value.

29. The method of claim 27, wherein the threshold value is a statistical value derived at least in part from the iLGD values of the credit instruments in the set.

30. The method of claim 23, wherein the step of identifying comprises identifying credit instruments in the set of credit instruments having only extreme large iLGD values.

31. The method of claim 23, wherein the step of identifying comprises identifying credit instruments in the set of credit instruments having extreme large iLGD values and identifying credit instrument in the set of credit instruments having extreme small iLGD values.

32. The method of claim 23, further comprising the step of transmitting information relating to the identified credit instruments via a network.

33. The method of claim 32, wherein the transmitted information includes the iLGD values of the identified credit instruments.
